(19) United States
(12) Patent Application Publication
(10) Pub. No.: US 2026/0195117 A1
(43) Pub. Date: Jul. 9, 2026

(54) SOFTWARE UPDATE SYSTEM, SOFTWARE UPDATE DEVICE, SOFTWARE UPDATE METHOD, AND STORAGE MEDIUM

(71) Applicant: HONDA MOTOR CO., LTD., TOKYO (JP)

(72) Inventors: Yujiro KOMIYAMA, TOKYO (JP); Yutaro YASUDA, TOKYO (JP); Yasumasa KAITANI, TOKYO (JP)

(21) Appl. No.: 19/441,114

(22) Filed: Jan. 6, 2026

(30) Foreign Application Priority Data
Jan. 9, 2025 (JP) 2025-003520

(51) Int. Cl. G06F 8/65

(52) U.S. Cl. CPC G06F 8/65

(57) ABSTRACT

A software update system includes an update control unit configured to execute a software update process, which is a process of updating software, for an electronic control unit provided in a vehicle, and a command request issuing unit provided in the vehicle and configured to issue a command request directed to a server device, wherein the command request issuing unit issues a command request during a period when at least a completion process of the software update process is not executed.

### CROSS-REFERENCE TO RELATED APPLICATIONS

This application is based upon and claims the benefit of priority from Japanese Patent Application No. 2025-003520 filed on Jan. 9, 2025, the contents of which are incorporated herein by reference.

### BACKGROUND OF THE INVENTION

### Field Of The Invention

The present disclosure relates to a software update system, a software update device, a software update method, and a storage medium.

### Description Of The Related Art

Recently, vehicles capable of updating Electronic Control Units by OTA (Over The Air) using wireless communication have become popular. A software update process is performed in response to campaign information transmitted to a vehicle prior to software update. Meanwhile, the software update process can be aborted by purging (discarding) the campaign information transmitted to the vehicle.

JP 2024-033161 A discloses a technique for aborting software update when an error occurs in software update (campaign).

### SUMMARY OF THE INVENTION

It is desirable to favorably abort the software update process when it is necessary to do so.

The present disclosure aims to solve the aforementioned problems.

A first aspect of the present disclosure is a software update system including a vehicle and a server device configured to communicate with the vehicle via a network, wherein the software update system includes an update control unit configured to execute a software update process, which is a process of updating software, for an electronic control unit provided in the vehicle, and a command request issuing unit provided in the vehicle and configured to issue a command request to the server device, wherein the command request issuing unit issues the command request during a period when at least a completion process of the software update process is not executed.

A second aspect of the present disclosure is a software update device including an update control unit configured to execute a software update process, which is a software update process, for an electronic control unit provided in a vehicle; and a command request issuing unit configured to issue a command request to a server device configured to communicate with the vehicle via a network, wherein the command request issuing unit issues the command request during a period when at least a completion process of the software update process is not executed.

A third aspect of the present disclosure is a software update method including an update control step of executing a software update process, which is a software update process, for an electronic control unit provided in a vehicle; and a command request issuing step of issuing a command request to a server device configured to communicate with the vehicle via a network, wherein in the command request issuing step, the command request is issued during a period when at least a completion process of the software update process is not executed.

A fourth aspect of the present disclosure is a program that causes a computer to execute the software update method of the third aspect.

According to the present disclosure, campaign information can be favorably purged.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram illustrating a software update system;

FIG. 2 is a flow diagram of a software update process;

FIG. 3 is a flow diagram of a purging process;

FIG. 4 is a diagram showing a period during which campaign information can be purged and a period during which campaign information cannot be purged;

FIG. 5 is a diagram for explaining the timing of a result log, a command request, and a purge command in the first embodiment;

FIG. 6 is a diagram for explaining the timing of the result log, the command request, and the purge command in the first embodiment;

FIG. 7 is a diagram for explaining the timing of the result log, the command request, and the purge command in the first embodiment;

FIG. 8 is a diagram for explaining the timing of the command request and the purge command in a reference example; and

FIG. 9 is a diagram for explaining the timing of a result log and a command request in the second embodiment.

### DETAILED DESCRIPTION OF THE INVENTION

Conventionally, software update for a vehicle-mounted electronic control unit (ECU) was performed at a dealer or the like. Recently, vehicles capable of updating ECU software over the air (OTA) using wireless communication have been commercially available. Such vehicles are capable of updating ECU software without being brought to a dealer or the like.

In a software update process via OTA, before update data used for software update is downloaded, campaign information, which is information about the software update process, is displayed for a user of a vehicle on a display unit of an in-vehicle infotainment (IVI) system or the like. The campaign information includes information about the name and version of the software on which the update process is performed, information requesting the user's permission for downloading the update data, and the like.

A software update device provided in a vehicle stores campaign information in a storage unit. If there is a defect in the campaign (for example, if a bug is found in update data), an OTA server (referred to as the server device) executes a process of causing the software update device to purge (discard) the campaign information stored in the storage unit. For example, the server device supplies a purge command to the software update device. The software update device that has acquired the purge command from the server device purges the campaign information stored in the storage unit. This prevents inappropriate software updates.

However, the software update device cannot purge the campaign information stored in the storage unit when the software update device acquires the purge command at the timing when the campaign information cannot be purged. In contrast, in the present disclosure, the software update device acquires the purge command at the timing when the campaign information can be purged. This suppresses inappropriate software update processes.

### 1 FIRST EMBODIMENT

### 1 -1 Configuration of Software Update System 10

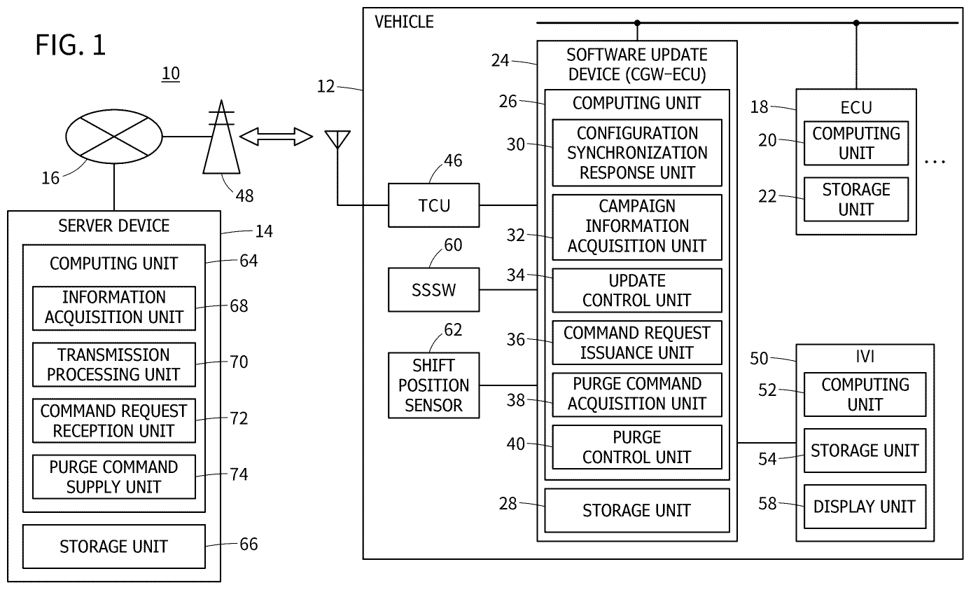

FIG. 1 is a schematic diagram illustrating a software update system 10. The software update system 10 includes a vehicle 12 and a server device 14. The server device 14 is capable of communicating with the vehicle 12 via a network 16.

A plurality of ECUs 18 are mounted in the vehicle 12. Each ECU 18 performs control to implement a traveling function and other functions of the vehicle 12. Each ECU 18 has a computing unit 20 and a storage unit 22. The computing unit 20 is a processor such as a CPU (Central Processing Unit), a GPU (Graphics Processing Unit), or the like. At least part of the computing unit 20 may be realized by an integrated circuit such as an ASIC (Application Specific Integrated Circuit), an FPGA (Field-Programmable Gate Array), or the like. At least part of the computing unit 20 may be realized by an electronic circuit including discrete devices.

The storage unit 22 is a computer-readable, non-transitory tangible storage medium. The storage unit 22 is composed of a volatile memory (not shown) and a nonvolatile memory (not shown). The volatile memory is, for example, RAM (Random Access Memory) or the like. The nonvolatile memory is, for example, ROM (Read Only Memory), flash memory, or the like. Data or the like are stored, for example, in the volatile memory. Programs, tables, maps, or the like are stored, for example, in the non-volatile memory. At least part of the storage unit 22 may be provided in the above-mentioned processor, integrated circuit, or the like. At least part of the storage unit 22 may be mounted in a device connected to the vehicle 12 via the network 16.

The vehicle 12 is equipped with a software update device 24. The software update device 24 may be constituted by, for example, a CGW-ECU (Central GateWay-Electronic Control Unit). The software update device 24 has a computing unit 26 and a storage unit 28. The computing unit 26 is, for example, a processor such as a CPU or a GPU. The computing unit 26 includes a configuration synchronization response unit 30, a campaign information acquisition unit 32, an update control unit 34, a command request issuance unit 36, a purge command acquisition unit 38, and a purge control unit 40. The configuration synchronization response unit 30, the campaign information acquisition unit 32, the update control unit 34, the command request issuance unit 36, the purge command acquisition unit 38, and the purge control unit 40 are realized by the computing unit 26 executing programs stored in the storage unit 28. At least part of the configuration synchronization response unit 30, the campaign information acquisition unit 32, the update control unit 34, the command request issuance unit 36, the purge command acquisition unit 38, and the purge control unit 40 may be realized by an integrated circuit such as an ASIC or an FPGA. At least part of the configuration synchronization response unit 30, the campaign information acquisition unit 32, the update control unit 34, the command request issuance unit 36, the purge command acquisition unit 38, and the purge control unit 40 may be realized by an electronic circuit including discrete devices.

The storage unit 28 is a computer-readable, non-transitory tangible storage medium. The storage unit 28 is composed of a volatile memory (not shown) and a nonvolatile memory (not shown). The volatile memory is, for example, RAM or the like. The non-volatile memory is, for example, ROM, flash memory, or the like. Data or the like are stored, for example, in the volatile memory. Programs, tables, maps, or the like are stored, for example, in the non-volatile memory. At least part of the storage unit 28 may be provided in the above-mentioned processor, integrated circuit, or the like. At least part of the storage unit 28 may be mounted in a device connected to the vehicle 12 via the network 16.

The software update device 24 performs the software update process for the ECU 18. The software update process includes a software download process, a software installation process, a software activation process, and a completion process.

The software download process includes a process of acquiring the update data transmitted from the server device 14 via the network 16 and storing the data in the storage unit 28 of the software update device 24. The update data is data including a program or the like of the updated software. The update data may include an installer or the like.

The software installation process includes a process of loading the update data of the storage unit 28 into the ROM of the ECU 18. The software installation process may be performed by an installer. The software installation process may be performed by copying update data to the ROM.

The software activation process includes the process of authenticating the license of the installed software. During the activation process of software, executable files and the like used by the prior-to-updating software may be rewritten. Upon completion of the software activation process, the execution of the software on the ECU 18 is allowed. The activation process may be performed by the software update device 24 or each ECU 18.

The completion process involves post-processing of the software update. For example, the completion process includes a process of uploading result logs to the server device 14 and a process of notifying the user that the software update has been completed. A result log includes information on whether the software update of the ECU 18 has been successful (execution result of the software update process), information on the time when the activation process has been completed, and the like.

The configuration synchronization response unit 30 transmits configuration synchronization information to the server device 14 in response to a configuration synchronization request transmitted from the server device 14. The campaign information acquisition unit 32 acquires campaign information, which is information related to the software update process, from the server device 14 and stores the campaign information in the storage unit 28. The update control unit 34 executes a software update process for the ECU 18. The command request issuing unit 36 issues a command request to the server device 14. The purge command acquisition unit 38 acquires a purge command, which is a command related to campaign purging, from the server device 14. The purge control unit 40 purges the campaign information stored in the storage unit 28 when the purge command acquisition unit 38 acquires the purge command.

The software update device 24 and the ECU 18 are connected by a CAN (Controller Area Network) (registered trademark in Japan) and can communicate with each other. A communication line connecting the software update device 24 and the ECU 18 is not limited to the CAN and may be an Ethernet (registered trademark in Japan), or both the CAN and the Ethernet may be used. Furthermore, as the communication line, a communication line according to other standards than CAN and Ethernet may be used.

The software update device 24 can communicate, via a Telematics Control Unit (TCU) 46, with a base station 48 connected to the network 16 through cellular communication. The network 16 is, for example, the Internet.

The IVI 50 is connected to the software update device 24. The IVI 50 has a computing unit 52 and a storage unit 54. The computing unit 52 is, for example, a processor such as a CPU or a GPU.

The storage unit 54 is a computer-readable, non-transitory tangible storage medium. The storage unit 54 is composed of a volatile memory (not shown) and a nonvolatile memory (not shown). The volatile memory is, for example, RAM or the like. The non-volatile memory is, for example, ROM, flash memory, or the like. Data or the like are stored, for example, in the volatile memory. Programs, tables, maps, or the like are stored, for example, in the non-volatile memory. At least part of the storage unit 54 may be provided in the above-mentioned processor, integrated circuit, or the like. At least part of the storage unit 54 may be mounted in a device connected to the vehicle 12 via the network 16.

The IVI 50 provides information such as display of road traffic information and route guidance and also provides entertainment through audio, DVD, TV tuner, and so on.

The IVI 50 has a display unit 58. The display unit 58 is installed on a dashboard or the like of the vehicle 12. The display unit 58 is a touch panel display. The display unit 58 provides the user with information via images, characters, and so on and accepts operation input performed by the user. The screen of the display unit 58 is not particularly limited and may be a liquid crystal, organic electroluminescence (organic EL), or the like. The touch panel of the display unit 58 is not particularly limited and may be a resistive film type, a capacitance type, or the like. Instead of the display unit 58 that is a touch panel display, a combination of a display device such as a head-up display and a pointing device such as motion capture may be used.

The vehicle 12 is equipped with a start-stop switch (SSSW) 60. The power modes of the vehicle 12 is switched by the user operating the SSSW 60. The SSSW 60 corresponds to the starting switch of the present invention. When the vehicle 12 is an engine vehicle, the power modes include an OFF mode, an ACC mode, an ON mode, and a START mode. When the vehicle 12 is a hybrid vehicle or an electric vehicle, the power modes include an OFF mode, an ACC mode, and a READY mode.

The OFF mode is a state in which the power source of the vehicle 12 is OFF. In the OFF mode, most of the equipment of the vehicle 12 cannot be used. Even in the OFF mode, a keyless entry system and the like can be used. The state of the SSSW 60 in the OFF mode may be referred to as IG-OFF or ACC-OFF. In the ACC mode, devices such as an audio device can be used. The state of the SSSW 60 in the ACC mode may be referred to as IG-OFF or ACC-ON. In the ON mode, all the equipment of the vehicle 12 can be used. The state of the SSSW 60 in the ON mode may be referred to as IG-ON. The START mode is a state in which the engine starts, and the vehicle 12 is allowed to travel after the engine starts. The READY mode is a state in which the vehicle 12 can travel by means of the drive motor. The state of the SSSW 60 in the READY mode may be referred to as READY.

The state of the SSSW 60 being IG-OFF corresponds to the state in which the starting switch of the present invention is OFF. The state of the SSSW 60 being IG-ON (or READY) corresponds to the state in which the starting switch of the present invention is ON.

The vehicle 12 is equipped with a shift position sensor 62. The shift position sensor 62 detects the shift position selected by the user's operation.

The server device 14 includes a computing unit 64 and a storage unit 66. The computing unit 64 is, for example, a processor such as a CPU or a GPU. The computing unit 64 includes an information acquisition unit 68, a transmission processing unit 70, a command request reception unit 72, and a purge command supply unit 74. The information acquisition unit 68, the transmission processing unit 70, the command request reception unit 72, and the purge command supply unit 74 are realized by the computing unit 64 executing programs stored in the storage unit 66. At least part of the information acquisition unit 68, the transmission processing unit 70, the command request reception unit 72, and the purge command supply unit 74 may be realized by an integrated circuit such as an ASIC or an FPGA. At least part of the information acquisition unit 68, the transmission processing unit 70, the command request reception unit 72, and the purge command supplying unit 74 may be realized by an electronic circuit including discrete devices.

The storage unit 66 is a computer-readable, non-transitory tangible storage medium. The storage unit 66 is composed of a volatile memory (not shown) and a nonvolatile memory (not shown). The volatile memory is, for example, RAM or the like. The non-volatile memory is, for example, ROM, flash memory, or the like. Data or the like are stored, for example, in the volatile memory. Programs, tables, maps, or the like are stored, for example, in the non-volatile memory. At least part of the storage unit 66 may be provided in the above-mentioned processor, integrated circuit, or the like. At least part of the storage unit 66 may be mounted in a device connected to the server device 14 via the network 16.

A plurality of vehicles 12 are registered in the server device 14, and the update status of the software of the ECUs 18 of each vehicle 12 is managed. The server device 14 provides each vehicle 12 with the update data for updating the software of the ECUs 18 of each vehicle 12.

### 1-2 Flow of Software Update Process

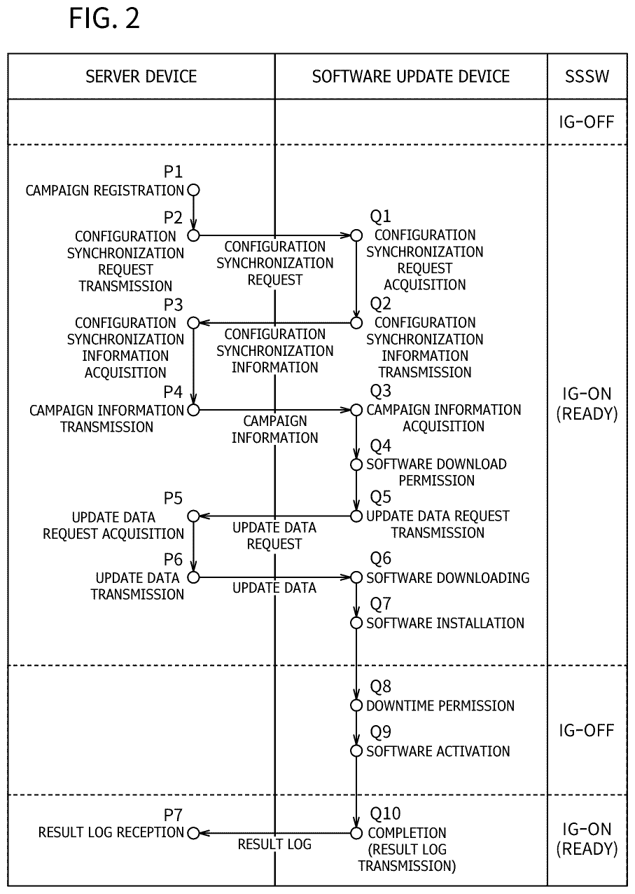

FIG. 2 is a flow diagram of a software update process. An overview of the software update process performed by the software update system 10 will be described with reference to FIG. 2.

After the campaign information is registered in the server device 14 (P1), the vehicle 12 issues a command request to the server device 14. If there is a campaign registered in the server device 14, the transmission processing unit 70 transmits a configuration synchronization request to the software update device 24 of the vehicle 12 (P2). The campaign information, together with the update data for updating the software of the ECU 18, is registered in the server device 14 by a software developer of the ECU 18, a manufacturer of the vehicle 12, and so on.

The configuration synchronization response unit 30 of the software update device 24 acquires the configuration synchronization request (Q1) and then transmits the configuration synchronization information to the server device 14 (Q2). The configuration synchronization information includes information on a unique identifier assigned to each ECU 18 of the vehicle 12, information on a version of the software of each ECU 18, and the like.

The configuration synchronization response unit 30 transmits the configuration synchronization information to the server device 14 not only when acquiring the configuration synchronization request transmitted from the server device 14 as described above. For example, when the user instructs the configuration synchronization via the IVI 50 or the like, the configuration synchronization response unit 30 may transmit the configuration synchronization information to the server device 14. Further, the configuration synchronization response unit 30 may periodically transmit the configuration synchronization information to the server device 14.

When the information acquisition unit 68 of the server device 14 acquires the configuration synchronization information (P3), the transmission processing unit 70 transmits to the software update device 24 the campaign information on the software update process for each ECU 18 (P4).

The campaign information acquisition unit 32 of the software update device 24 acquires the campaign information (Q3) and stores the campaign information in the storage unit 28. The update control unit 34 causes the display unit 58 of the IVI 50 to display the campaign information. A confirmation process of confirming with the user whether to permit the software download is performed by the update control unit 34. In this confirmation process, when the user permits the software download (Q4), the update control unit 34 transmits an update data request to the server device 14 (Q5).

When the information acquisition unit 68 of the server device 14 acquires the update data request (P5), the transmission processing unit 70 transmits the update data to the software update device 24 (P6).

The update control unit 34 of the software update device 24 executes the software download process. That is, the update control unit 34 acquires the update data and stores the update data in the storage unit 28, thereby downloading the software (Q6). Then, the update control unit 34 executes the software installation process. That is, the update control unit 34 loads the update data of the storage unit 28 into the ROM of the ECU 18 and thereby installs the software (Q7).

When the state of the SSSW 60 is switched from IG-ON (or READY) to IG-OFF and the shift position detected by the shift position sensor 62 is “P”, the update control unit 34 performs a confirmation process of confirming with the user whether to permit the downtime. In this confirmation process, when the user permits the downtime (Q8), the update control unit 34 executes a software activation process for the ECU 18 (Q9). The downtime indicates a time period during which the power mode of the vehicle 12 cannot be set to the START mode or the READY mode and the vehicle 12 cannot start traveling while the software activation process is performed. Once the software activation process is completed, the power mode of the vehicle 12 can be set to the START or READY mode.

When the software activation process is completed and the state of the SSSW 60 is switched from IG-OFF to IG-ON (or READY), the update control unit 34 executes the completion process (Q10). For example, the update control unit 34 uploads (transmits) a result log to the server device 14. The result log includes information on whether the software of the ECU 18 has been successfully updated, the time when the activation has been completed, and the like. The update control unit 34 also causes the display unit 58 of the IVI 50 to display a completion notification indicating that the software update has been completed.

When the information acquisition unit 68 of the server device 14 acquires the result log (P7), the updating of the software comes to an end.

### 1-3 Flow of Purge Process

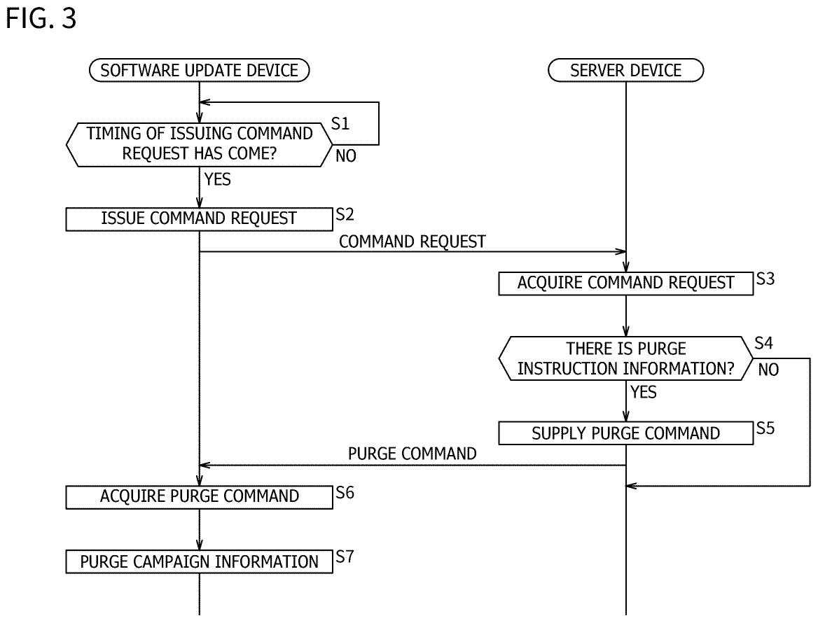

FIG. 3 is a flow diagram of the purging process. There are cases where defects are found in the software that is a target of the campaign after the campaign information is transmitted from the server device 14 to the software update device 24. In this case, purge instruction information indicating an instruction to purge (discard) the campaign information is registered in the server device 14. The purge instruction information is stored in the storage unit 66.

In step S1, the command request issuing unit 36 of the software update device 24 determines whether the timing of issuing a command request has come. The timing of issuing the command request is set beforehand. The timing of issuing the command request will be described later. When the timing of issuing the command request arrives (step S1: YES), the process proceeds to step S2. On the other hand, if the timing of issuing the command request has not yet arrived (step S1: NO), the process of step S1 is executed again.

When the process proceeds from step S1 to step S2, the command request issuing unit 36 issues the command request directed to the server device 14. The command request is supplied to the server device 14 via the network 16.

In step S3, the command request reception unit 72 of the server device 14 accepts the command request supplied from the software update device 24.

In step S4, the purge command supply unit 74 of the server device 14 determines whether there is the purge instruction information. If there is the purge instruction information stored in the storage unit 66 (step S4: YES), the process proceeds to step S5. On the other hand, if there is no purge instruction information stored in the storage unit 66 (step S4: NO), the series of processes shown in FIG. 3 ends.

When the process proceeds from step S4 to step S5, the purge command supply unit 74 supplies a purge command, which is a command (request command) related to purging of campaign information, to the software update device 24. The purge command is supplied to the software update device 24 via the network 16.

In step S6, the purge command acquisition unit 38 of the software update device 24 acquires the purge command supplied from the server device 14.

In step S7, the purge control unit 40 of the software update device 24 purges the campaign information stored in the storage unit 28 in response to the purge command. Here, the purge control unit 40 purges, among the campaign information stored in the storage unit 28, all the campaign information that can be purged. The reason why the purge control unit 40 purges all the campaign information that can be purged is as follows.

For example, we assume a case where only campaigns with defects are purged while the software update process is executed for campaigns having no defects. In this case, a process is needed for determining in the vehicle 12 whether the combination of software that has been updated and software that has not yet been updated is appropriate. This complicates the process performed in the vehicle 12. On the other hand, by purging all the campaign information that can be purged and re-acquiring defect-free campaigns, it is possible to simplify the process performed in the vehicle 12.

### 1-4 Timing of Command Request Issue

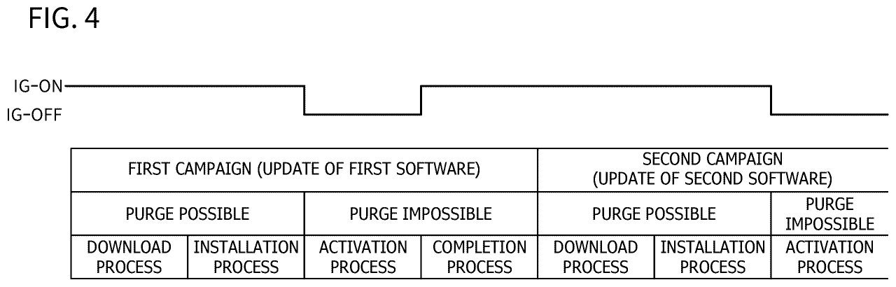

FIG. 4 is a diagram showing, concerning two campaigns, the periods during which purging is possible and the periods during which purging is not possible. The following description relates to a purge process performed by the software update device 24 when two pieces of campaign information are stored in the storage unit 28 of the software update device 24.

One of the two campaigns is referred to as the first campaign, and the other of the two campaigns is referred to as the second campaign. The software updated in the first campaign is referred to as the first software, and the software updated in the second campaign is referred to as the second software. The first campaign information, which is the campaign information concerning the first campaign, is information on the update of the software provided in the ECUs 18 of the first group. The second campaign information, which is the campaign information concerning the second campaign, is information on the update of the software provided in the ECUs 18 of the second group different from the first group. Each group contains one or more ECUs 18. That is, the campaign information may include information on the update of one piece of software or information on the update of a plurality of pieces of software.

The update control unit 34 of the software update device 24 executes the software update process that is in accordance with the campaign information. During one driving cycle, the update control unit 34 can start only the software update process that is in accordance with one piece of campaign information. Therefore, the update control unit 34 executes the first-software update process during the first driving cycle and executes the second-software update process during the second driving cycle that comes after the first driving cycle. The execution period of the software update process in accordance with one campaign information includes the timing of the IG-OFF and the timing of the IG-ON coming next.

The period from when the software download process starts to when the software installation process ends is a period during which the purge control unit 40 can purge the campaign information. On the other hand, the period from when the software activation process starts to when the software completion process ends is a period during which the purge control unit 40 cannot purge the campaign information.

In the situation shown in FIG. 4, the purge control unit 40 can purge the first campaign information and the second campaign information during the period from when the first-software download process starts to when the first-software installation process ends. Although not shown in FIG. 4, the purge control unit 40 can also purge the first campaign information and the second campaign information before the first-software download process starts. On the other hand, the purge control unit 40 cannot purge the first campaign information and the second campaign information during the period from when the first-software activation process starts to when the first-software completion process ends.

After the first-software completion process is completed, the first-software update process itself is completed. Therefore, naturally, after the first-software completion process is completed, the purge control unit 40 cannot purge the first campaign information.

During the period from when the second-software download process starts to when the second-software installation process ends, the purge control unit 40 can purge the second campaign information. Although not shown in FIG. 4, the purge control unit 40 can also purge the second campaign information during the period from when the first-software completion process ends until the second-software download process starts.

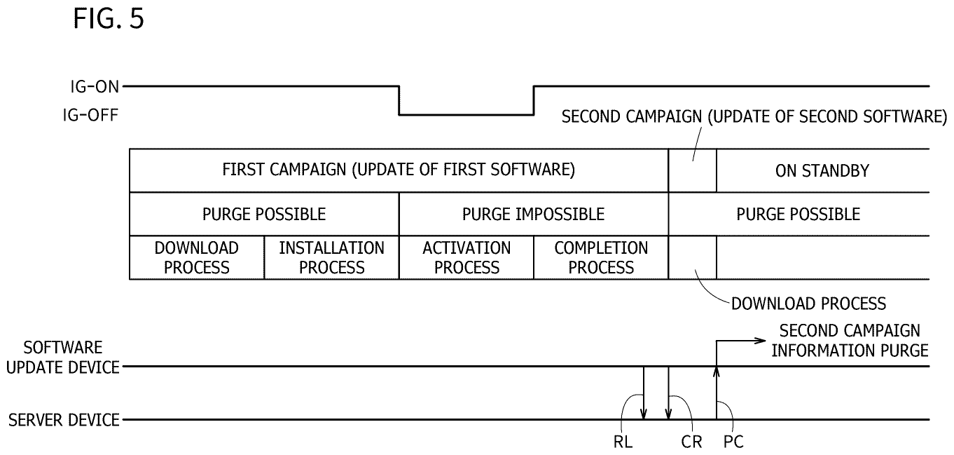

FIGS. 5 to 7 are diagrams for explaining the timing of the result log, the command request, and the purge command in the first embodiment. In each figure, an arrow RL indicates that the result log is uploaded from the software update device 24 to the server device 14. An arrow CR indicates that the command request is issued from the software update device 24 to the server device 14. An arrow PC indicates that the purge command is supplied from the server device 14 to the software update device 24.

As shown in FIG. 5, in the first-software completion process, the update control unit 34 of the software update device 24 uploads the result log related to the first-software update process to the server device 14 (arrow RL). After the update control unit 34 uploads the result log to the server device 14, the command request issuing unit 36 of the software update device 24 may issue a command request directed to the server device 14 (arrow CR). For example, the command request issuing unit 36 may issue the command request after the completion process ends (including a time point when the completion process ends). Alternatively, the command request issuing unit 36 may issue the command request at a time point when a predetermined time has elapsed after the result log is uploaded.

The purge command supply unit 74 of the server device 14 supplies the purge command to the software update device 24 in response to the command request (arrow PC). In this case, the purge command acquisition unit 38 of the software update device 24 can acquire the purge command during the execution of the second-software download process (or before the execution of the download process). That is, the purge command acquisition unit 38 can acquire the purge command during the period in which purging is possible. Thus, the purge control unit 40 of the software update device 24 can purge the second campaign information according to the purge command.

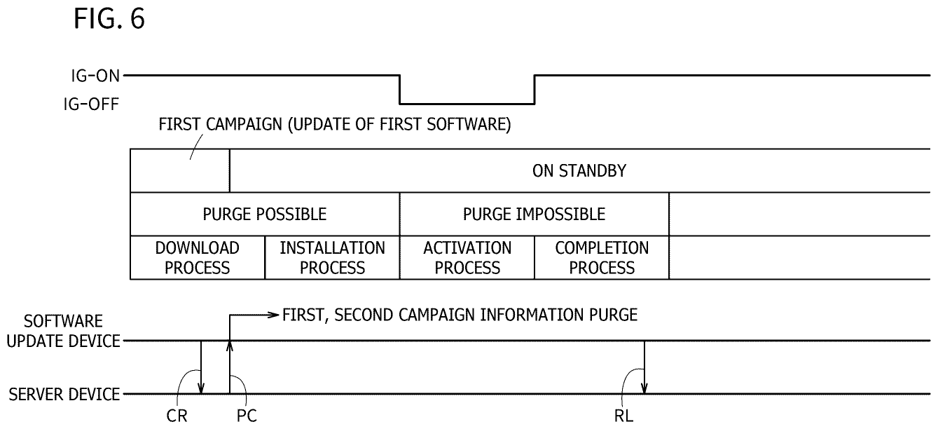

As shown in FIG. 6, while the update control unit 34 of the software update device 24 is executing the first-software download process, the command request issuing unit 36 of the software update device 24 may issue the command request to the server device 14 (arrow CR).

The purge command supply unit 74 of the server device 14 supplies the purge command to the software update device 24 in response to the command request (arrow PC). In this case, the purge command acquisition unit 38 of the software update device 24 can acquire the purge command during the execution of the first-software download process. That is, the purge command acquisition unit 38 can acquire the purge command during the period in which purging is possible. Thus, the purge control unit 40 of the software update device 24 can purge each of the first campaign information and the second campaign information.

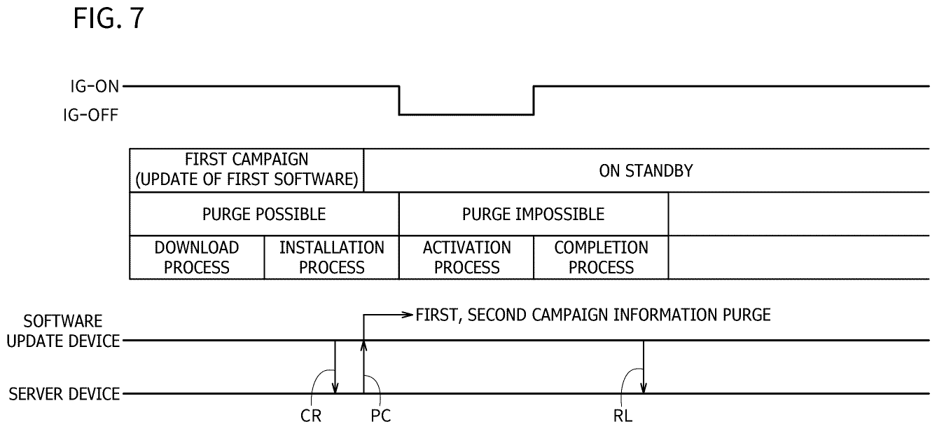

As shown in FIG. 7, while the update control unit 34 of the software update device 24 is executing the first-software installation process, the command request issuing unit 36 of the software update device 24 may issue the command request to the server device 14 (arrow CR).

The purge command supply unit 74 of the server device 14 supplies the purge command to the software update device 24 in response to the command request (arrow PC). In this case, the purge command acquisition unit 38 of the software update device 24 can acquire the purge command during the execution of the first-software installation process. That is, the purge command acquisition unit 38 can acquire the purge command during the period in which purging is possible. Thus, the purge control unit 40 of the software update device 24 can purge each of the first campaign information and the second campaign information.

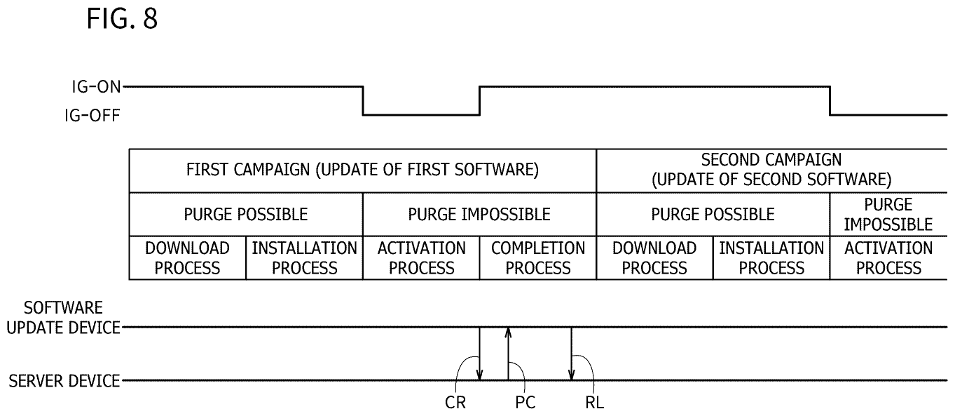

FIG. 8 is a diagram for explaining the timing of the command request and the purge command in a reference example. For example, at the timing when the state of the SSSW 60 is switched from IG-OFF to IG-ON (or READY), the command request issuing unit 36 of the software update device 24 issues the command request directed to the server device 14 (arrow CR).

The purge command supply unit 74 of the server device 14 supplies the purge command to the software update device 24 in response to the command request (arrow PC). In this case, the purge command acquisition unit 38 of the software update device 24 acquires the purge command during the execution of the first-software completion process. That is, the purge command acquisition unit 38 acquires the purge command during the period in which purging is impossible. Therefore, the purge control unit 40 of the software update device 24 cannot purge the second campaign information.

According to the first embodiment, the software update device 24 provided in the vehicle 12 can acquire the purge command at a timing (timing during a period other than the execution period of each of the activation process and the completion process) at which the campaign information can be purged. This suppresses inappropriate software update processes.

### 2 SECOND EMBODIMENT

In the first embodiment, the command request issuing unit 36 of the software update device 24 issues the command request at a fixed timing regardless of the presence or absence of campaign information. On the other hand, in the second embodiment, the command request issuing unit 36 switches the issuing timing of the command request based on the presence or absence of campaign information.

When there is the campaign information stored in the storage unit 28 of the software update device 24, the command request issuing unit 36 issues the command request at the same timing as that in the first embodiment. For example, as shown in FIG. 6 or 7, the command request issuing unit 36 issues the command request during the period from when the first-software download process starts to when the first-software installation process ends.

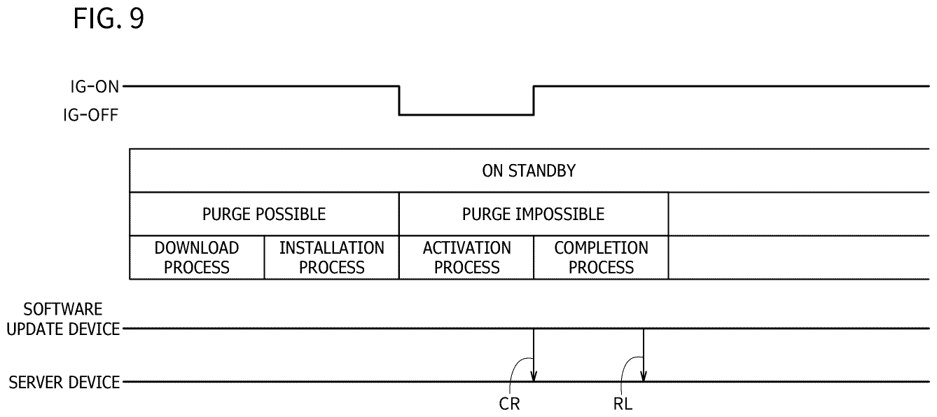

On the other hand, if there is no campaign information stored in the storage unit 28 of the software update device 24, the command request issuing unit 36 issues the command request at the timing when the state of the SSSW 60 is switched from IG-OFF to IG-ON (or READY) as shown in FIG. 9 (arrow CR).

Similar to the first embodiment, according to the second embodiment, the software update device 24 provided in the vehicle 12 can acquire the purge command at a timing at which the campaign information can be purged. This suppresses inappropriate software update processes.

### 3 SUPPLEMENTARY NOTE

With respect to the above embodiments, the following supplementary notes are further disclosed.

### Supplementary Note 1

A software update system (10) of the present disclosure includes a vehicle (12), a server device (14) configured to communicate with the vehicle via a network (16), and an update control unit (34) configured to execute a software update process, which is a process of updating software, for an electronic control unit (18) provided in the vehicle, and a command request issuing unit (36) provided in the vehicle and configured to issue a command request directed to the server device, wherein the command request issuing unit issues the command request during a period when at least a completion process of the software update process is not executed.

According to the configuration of supplementary note 1, the vehicle can acquire the purge command at the timing when the campaign information can be purged. This suppresses inappropriate software update processes.

### Supplementary Note 2

In the software update system described in supplementary note 1, the command request issuing unit may issue the command request during a period when neither the activation process to be executed before the completion process nor the completion process is executed.

### Supplementary Note 3

In the software update system described in supplementary note 2, the command request issuing unit may issue the command request after the completion processing is completed.

### Supplementary Note 4

In the software update system according to supplementary note 1, the complete process may include a process of uploading to the server device a log related to an execution result of the software update process, and the command request issuing unit may issue the command request after the log is uploaded to the server device.

### Supplementary Note 5

The software update system described in supplementary note 1 may further include a campaign information acquisition unit (32) configured to acquire campaign information, which is information related to the software update process, from the server device via the network and stores the campaign information in a storage unit (28), wherein the command request issuance unit may issue the command request based on an event that a start switch (60) of the vehicle is turned on, when the campaign information is not stored in the storage unit, and the command request issuance unit may issue, in a case where the campaign information is stored in the storage unit, the command request during a period from when the software download process starts until when the software installation process is completed.

### Supplementary Note 6

The software update system described in supplementary note 1 may further include a campaign information acquisition unit configured to acquire campaign information, which is information related to the software update process, from the server device via the network and store the campaign information in a storage unit, a purge command acquisition unit (38) configured to acquire a purge command, which is a command related to purging the campaign information, from the server device via the network, and a purge control unit (40) configured to purge the campaign information stored in the storage unit in a case where the purge command acquisition unit acquires the purge command, and the server device may supply the purge command to the purge command acquisition unit in response to the command request supplied from the command request issuance unit.

### Supplementary Note 7

A software update device (24) of the present disclosure includes an update control unit configured to execute a software update process, which is a software update process, for an electronic control unit provided in a vehicle, and a command request issuing unit configured to issue a command request to a server device configured to communicate with the vehicle via a network, wherein the command request issuing unit issues the command request during a period when at least a completion process of the software update process is not executed.

According to the configuration of supplementary note 7, the vehicle can acquire the purge command at the timing when the campaign information can be purged. This suppresses inappropriate software update processes.

### Supplementary Note 8

A software update method of the present disclosure includes an update control step of executing a software update process, which is a software update process, for an electronic control unit provided in a vehicle, and a command request issuance step of issuing a command request to a server device configured to communicate with the vehicle via a network, wherein in the command request issuance step, the command request is issued during a period when at least a completion process of the software update process is not executed.

According to the configuration of supplementary note 8, the vehicle can acquire the purge command at the timing when the campaign information can be purged. This suppresses inappropriate software update processes.

### Supplementary Note 9

A program of the present disclosure causes a computer to perform the software update method described in supplementary note 8.

Although the present disclosure has been detailed, the present disclosure is not limited to the individual embodiments described above. These embodiments may be variously added, replaced, altered, partially deleted, etc., without departing from the scope of the present disclosure or the intent of the present disclosure as derived from the claims and their equivalents. These embodiments can also be implemented in combination. For example, in the above-described embodiment, the order of the operations and the order of the processes are shown as an example and are not limited to these. The same applies to the case where numerical values or mathematical expressions are used in the description of the above-described embodiment.

1. A software update system comprising:
a vehicle;
a server device configured to communicate with the vehicle via a network; and
one or more processors that execute computer-executable instructions stored in a memory,
wherein the one or more processors execute the computer-executable instructions to cause the software update system to:
execute a software update process, which is a process of updating software, for an electronic control unit provided in the vehicle; and
issue a command request directed to the server device from the vehicle during a period when at least a completion process of the software update process is not executed.

2. The software update system according to claim 1,
wherein the one or more processors execute the computer-executable instructions to cause the software update system to issue the command request during a period when neither an activation process to be executed before the completion process nor the completion process is executed.

3. The software update system according to claim 2,
wherein the one or more processors execute the computer-executable instructions to cause the software update system to issue the command request after the completion process is completed.

4. The software update system according to claim 1,
wherein the completion process includes a process of uploading to the server device a log related to an execution result of the software update process, and
the one or more processors execute the computer-executable instructions to cause the software update system to issue the command request after the log is uploaded to the server device.

5. The software update system according to claim 1,
wherein the one or more processors execute the computer-executable instructions to cause the software update system to:
cause the vehicle to acquire campaign information, which is information on the software update process, from the server device via the network and store the campaign information in a storage unit provided in the vehicle; and
issue, in a case where the campaign information is not stored in the storage unit, the command request based on turning-on of a start switch of the vehicle; and
issue, in a case where the campaign information is stored in the storage unit, the command request during a period from when a software download process of software is started until when a installation process of software is completed.

6. The software update system according to claim 1,
wherein the one or more processors execute the computer-executable instructions to cause the software update system to:
cause the vehicle to acquire campaign information, which is information on the software update process, from the server device via the network and store the campaign information in a storage unit provided in the vehicle;
acquire a purge command, which is a command related to purging of the campaign information, from the server device via the network;
purge the campaign information stored in the storage unit in a case where the purge command is acquired; and
supply the purge command in response to the command request.

7. A software update device comprising
one or more processors that execute computer-executable instructions stored in a memory,
wherein
the one or more processors execute the computer-executable instructions to cause the software update device to:
execute a software update process, which is a software update process, for an electronic control unit provided in a vehicle; and
issue, during a period when at least a completion process of the software update process is not executed, a command request directed to a server device configured to communicate with the vehicle via a network.

8. A software update method executed by one or more processors, the method comprising:
executing a software update process, which is a software update process, for an electronic control unit provided in a vehicle; and
issuing a command request directed to a server device configured to communicate with the vehicle via a network,
wherein
in the issuing of the command request, the command request is issued during a period when at least a completion process of the software update process is not executed.

9. A non-transitory storage medium storing a program for causing a computer to execute the software update method according to claim 8.
